(19) United States
(12) Patent Application Publication
(10) Pub. No.: US 2013/0234967 A1
(43) Pub. Date: Sep. 12, 2013

(54) PRESSURE SENSITIVE MULTI-TIP STYLUS FOR CAPACITIVE TOUCHSCREENS AND METHODS OF USING SAME

(71) Applicant: Matthew Stoddard, Atlanta, GA (US)

(72) Inventor: Matthew Stoddard, Atlanta, GA (US)

(21) Appl. No.: 13/797,330

(22) Filed: Mar. 12, 2013

Related U.S. Application Data
(60) Provisional application No. 61/609,660, filed on Mar. 12, 2012.

(51) Int. Cl. G06F 3/0354

(52) U.S. Cl. CPC G06F 3/03545
USPC 345/173; 345/179

(57) ABSTRACT

An exemplary embodiment of the present invention provides a stylus for interfacing with a capacitive touchscreen device. The stylus comprises a stylus bode and a plurality of arms extending from the stylus body via a coupling. Each of the plurality of arms can be coupled to a conductive tip at a first end of the arms for interfacing with the capacitive touchscreen device. The coupling can allow the plurality of tips to move relative to one another when pressure is applied to one or more of the plurality of arms by a user of the stylus. During use, the movement of the tips relative to one another can be indicative of an input to the capacitive touchscreen device.

### CROSS-REFERENCE TO RELATED APPLICATIONS

This application claims the benefit of U.S. Provisional Application Ser. No. 61/609,660, filed on 12 Mar. 2012, which is incorporated herein by reference in its entirety as if fully set forth below.

### TECHNICAL FIELD OF THE INVENTION

The various embodiments of the present disclosure relate generally to user input devices for touchscreen devices. More particularly, various embodiments of the present invention are directed to pressure-sensitive, multi-tip styli for providing an input to a touchscreen device and methods of using the same.

### BACKGROUND OF THE INVENTION

Conventional styli are designed to emulate the use of a pen or pencil on paper in conjunction with the use of a touchscreen device. Styli for capacitive touchscreens such as U.S. patent application Ser. No. 12/101,936 and U.S. patent application Ser. No. 12/106,200 use a single, fixed tip for input. These single tip styli allow only for an “on” (in contact with the touchscreen) or “off” (not in contact with the touchscreen) position and afford no deeper interaction with the touchscreen than what the user's finger would afford.

In U.S. patent application Ser. No. 12/475,774 the styli was improved upon by adding a second touch input through a second maneuverable arm and tip. However, these two tips are allowed to move freely without direct correlation in their movements.

U.S. patent application Ser. No. 12/475,774 also lacks an indication to visualize to the user the center point between the multiple tips. Thus, U.S. patent application Ser. No. 12/475,774 may be used to select multiple items on a touchscreen at once, but would not be useful for actions such as handwriting or drawing.

It would be advantageous to provide an improved stylus for capacitive touchscreens, having two or more conductive drawing tips that provide user input for actions, such as drawing a line. It is to such a stylus that the present invention is primarily directed.

### BRIEF SUMMARY OF THE INVENTION

The present invention relates to pressure-sensitive, multi-tip styli for interfacing with a touchscreen device. The present invention preferably comprises an improved stylus for capacitive touchscreens, having two or more conductive tips that interface with the touchscreen to provide user input for actions, such as drawing a line. These two tips can be attached to two or more separate arms and have an elastic spring force pushing them outward. The user can squeeze these two arms together with their thumb and fingers which in turn moves the tips in relation to one another, e.g., closer to each other. A mechanism between the arms can ensure that the tips travel the same distance, and in unison, to keep the center point between the tips substantially constant. An indicator can be placed to show the user the precise center point between the two tips. The movement of the stylus can indicate to the touchscreen device the user's desire to draw a line directly beneath this indicator at the center point between the two tips. The movement of the tips towards or away from one another could change a property (such as line width) of the line they are drawing. For instance, as you draw a line with a light grip on the pen, the line width would be narrow, and if you grip tighter, which would move the drawing tips closer together, the line width on the screen would become thicker. This type of action mimics the way a real writing device works on paper—a user presses down harder to make a line thicker.

An exemplary embodiment of the present invention provides a stylus for a capacitive touchscreen comprising, a stylus body, a plurality of arms, and an indicator. The plurality of arms can extend from the stylus body via a coupling. Each of the arms can be coupled to a conductive tip at a first end of the arm for interfacing with the capacitive touchscreen. The coupling can allow the plurality of tips to move relative to one another when pressure is applied to one or more of the plurality of arms by a user of the stylus. The indicator can be positioned substantially between the plurality of tips and provide a visual indication of a center point among the plurality of the conductive tips.

In some embodiments of the present invention, the coupling comprises a pin-in-slot joint such that when the pressure is applied to one or more of the plurality of arms, a first tip in the plurality of tips moves a first distance and a second tip in the plurality of tips moves a second distance substantially equal to the first distance.

In some embodiments of the present invention, the coupling comprises one or more gears such that when the pressure is applied to one or more of the plurality of arms, a first tip in the plurality of tips moves a first distance and a second tip in the plurality of tips moves a second distance substantially equal to the first distance.

In some embodiments of the present invention, at least a portion of the indicator comprises a non-conductive material.

In some embodiments of the present invention, the stylus further comprises one or more springs coupled to one or more of the plurality of arms, the one or more springs applying an outward force to the one or more plurality of arms.

In some embodiments of the present invention, at least a portion of one or more of the plurality of arms comprises a conductive material providing electrical communication with the conductive tip of the one or more arms.

In some embodiments of the present invention, the plurality of arms have an open position and a closed position. The open position can result in a maximum distance between the plurality of tips. The closed position can result in a minimum distance between the plurality of tips. The arms can move to various positions between the open and closed position when varying amounts of pressure are applied to one or more of the plurality of arms by a user of the stylus.

In some embodiments of the present invention, the stylus further comprises a locking mechanism for holding the plurality of arms in the closed position.

Another exemplary embodiment of the present invention provides a stylus for providing an input to a touchscreen device. The stylus comprises a plurality of tips and an elastic rail. The plurality of tips can be for interfacing with the touchscreen device. The elastic rail can be attached to at least one of the tips, such that pressure applied to the elastic rail actuates the drawing tips closer together or farther apart in relation to one another.

In some embodiments of the present invention, the stylus can further comprise an indicator visualizing to a user a center point among the plurality of the tips.

In some embodiments, the stylus can further comprise a housing enclosing the elastic rail.

In some embodiments of the present invention, the stylus can further comprise a central shaft body enclosed by the elastic rail.

In some embodiments of the present invention, the stylus can further comprise a pin-in-slot joint attached to the elastic rail ensuring that movement of one end of the elastic rail results in a substantially equal movement of the opposite end of the elastic rail.

In some embodiments of the present invention, at least one tip and the elastic rail are made of a conductive material.

In addition to styli for interfacing with a touchscreen device, the present invention provides methods of using a stylus to interface with a touchscreen device. An exemplary embodiment of the present invention provides a method of interfacing with a touchscreen device. The method comprises providing a stylus comprising a first arm and a second arm, positioning first ends of the first and second arms proximate the surface of the touchscreen device, and actuating the first and second arms to vary a distance between the first ends of the first and second arms. The distance between the first ends of the first and second arms can be indicative of an input to the touchscreen device.

In some embodiments of the present invention, actuating the first and second arms can comprise applying pressure to the arms by a user. The pressure can cause the first ends of the first and second arms to move closer to each other.

In some embodiments of the present invention, positioning the first ends of the first and second arms proximate the surface of the touchscreen device can comprise placing a user in electrical communication with the touchscreen device via the first and second arms.

In some embodiments of the present invention, at least a portion of the first and second arms, including the first ends of the first and second arms, comprises a conductive material. Thus, in some embodiments of the present invention, positioning the first ends of the first and second arms proximate the surface of the touchscreen device can comprise placing a user in contact with the conductive material.

In some embodiments of the present invention, the input to the touchscreen device can be a discrete input.

In some embodiments of the present invention, the input to the touchscreen device can be an analog input.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The following Detailed Description of the Invention is better understood when read in conjunction with the appended drawings. For the purposes of illustration, there is shown in the drawings exemplary embodiments, but the subject matter is not limited to the specific elements and instrumentalities disclosed.

FIG. 1A is a perspective view of a dual-tip stylus showing the stylus arms in the closed position, in accordance with an exemplary embodiment of the present invention.

FIG. 1B is a schematic diagram of the stylus of FIG. 1A with the arms in the open position, in accordance with an exemplary embodiment of the present invention.

FIG. 2 is a schematic diagram of a dual-tip stylus, in accordance with an exemplary embodiment of the present invention.

FIG. 3 is a schematic diagram of a dual-tip stylus, in accordance with an exemplary embodiment of the present invention.

### DETAILED DESCRIPTION OF THE INVENTION

To facilitate an understanding of the principles and features of the present invention, various illustrative embodiments are explained below. To simplify and clarify explanation, the invention is described below as relating to a stylus for use with capacitive touchscreen devices. One skilled in the art will recognize, however, that the invention is not limited to capacitive touchscreen devices, but instead, as those skilled in the art would understand, the various embodiments of the present invention also find application for use with other non-capacitive touchscreen devices, such as pressure sensitive touchscreens, or many other applications where it is desirable to provide an input to a device.

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed herein as from “about,” “substantially,” or “approximately” one particular value and/or to “about,” “substantially,” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The components, steps, and materials described hereinafter as making up various elements of the invention are intended to be illustrative and not restrictive. Many suitable components, steps, and materials that would perform the same or similar functions as the components, steps, and materials described herein are intended to be embraced within the scope of the invention. Such other components, steps, and materials not described herein can include, but are not limited to, similar components or steps that are developed after development of the invention.

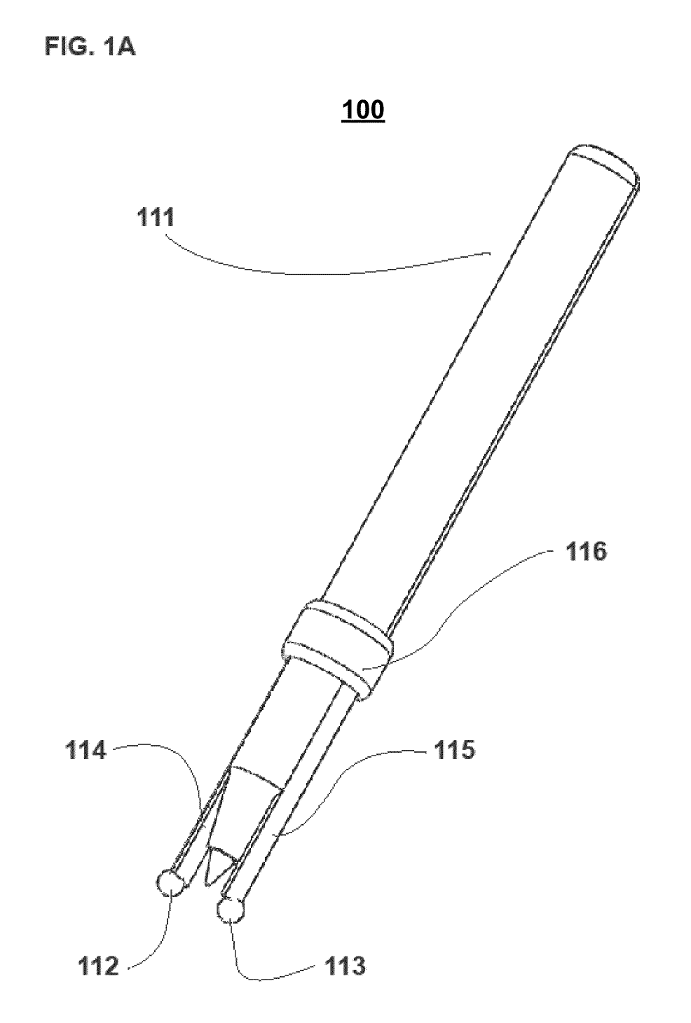

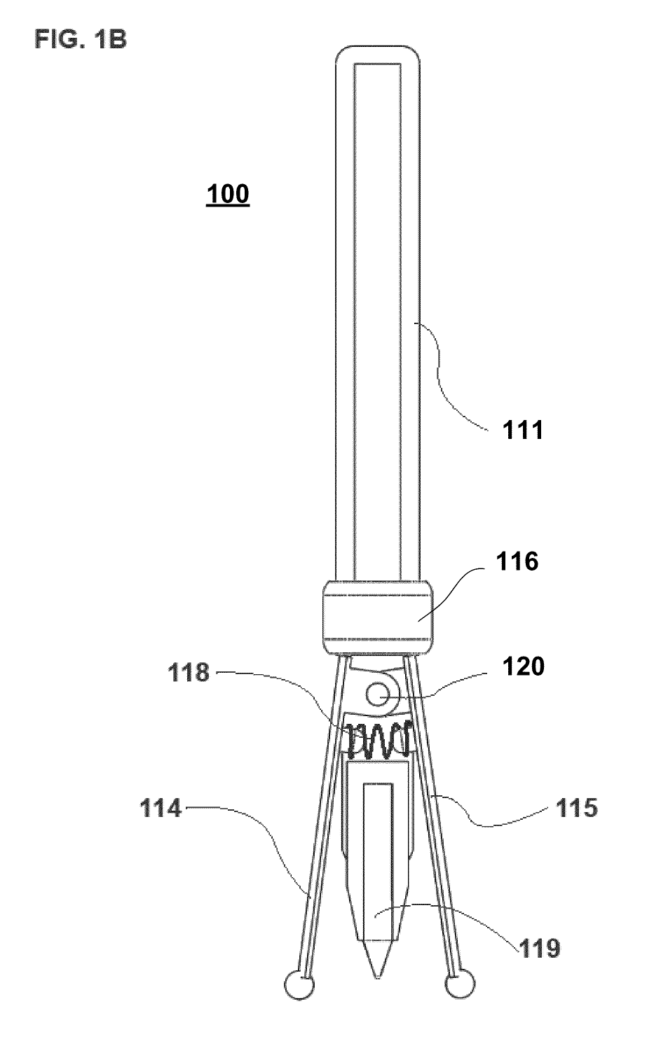

As shown in FIGS. 1A-1B, an exemplary embodiment of the present invention provides a stylus 100 for a capacitive touchscreen comprising a stylus body 111, a plurality of arms 114 115, and an indicator 119. The stylus body 111 can serve as a support structure for the stylus 100, such that a user may hold the stylus body 111 during use of the stylus 100. The stylus body 111 can be comprised of many conductive and/or non-conductive materials known in the art, including, but not limited to, metals, plastics, alloys, and the like. In an exemplary embodiment of the present invention, the stylus body 111 comprises aluminum. In another exemplary embodiment of the present invention, the stylus body 111 comprises a conductive plastic. Additionally, the stylus body 111 can be many shapes in accordance with various embodiments of the present invention.

As discussed above, the stylus 100 can comprise a plurality of arms 114 115. The plurality of arms 114 115 can be comprised of many conductive and/or non-conductive materials known in the art, including, but not limited to, metals, plastics, alloys, and the like. In an exemplary embodiment of the present invention, the plurality of arms 114 115 comprise aluminum. In another exemplary embodiment of the present invention, the plurality of arms 114 115 comprise a conductive plastic. As used herein, the term “plurality” should be interpreted as two or more. The exact number of arms of the stylus can vary in accordance with various embodiments of the present invention. For purposes of illustration, as shown in FIGS. 1A-1B, the stylus comprises two arms 114 115. The present invention, however, is not so limited. Instead, as those skilled in the art would appreciate, various embodiments of the present invention may comprise more than two arms.

In some embodiments of the present invention, each of the arms 114 115 can be coupled to a tip 112 113 at a first end of the arm for interfacing with the capacitive touchscreen. The tips 112 113 can be comprised of many conductive and/or non-conductive materials known in the art, including, but not limited to, metals, plastics, alloys, and the like. In an exemplary embodiment of the present invention, the tips 112 113 comprise aluminum. In another exemplary embodiment of the present invention, the tips 112 113 comprise a conductive plastic. In some embodiments of the present invention, the tips 112 113 can be a separately manufactured element attached to the arms. For example, in some embodiments, a tip can be attached to an arm via an adhesive. In other embodiments of the present invention, however, the tip can be integral with the arm. For example, the tip and the arm can be made from the same piece of material, i.e., of unitary construction. During use of the stylus 100, the tips 112 113 can interface/contact the touchscreen to provide an input to the touchscreen device. The tips 112 113 can be many shapes and sizes in accordance with various embodiments of the present invention. Some touchscreen devices only recognize a stylus, or other interfacing device, with tips having a cross-sectional area or diameter greater than a predetermined threshold. Accordingly, various embodiments of the present invention can be designed to have tips satisfying these minimum thresholds, depending on the touchscreen device that will be used. Additionally, some embodiments of the present invention may be accompanied with interchangeable tips having various cross-sectional areas and/or diameters that can be used with numerous touchscreen devices or applications on those touchscreen devices.

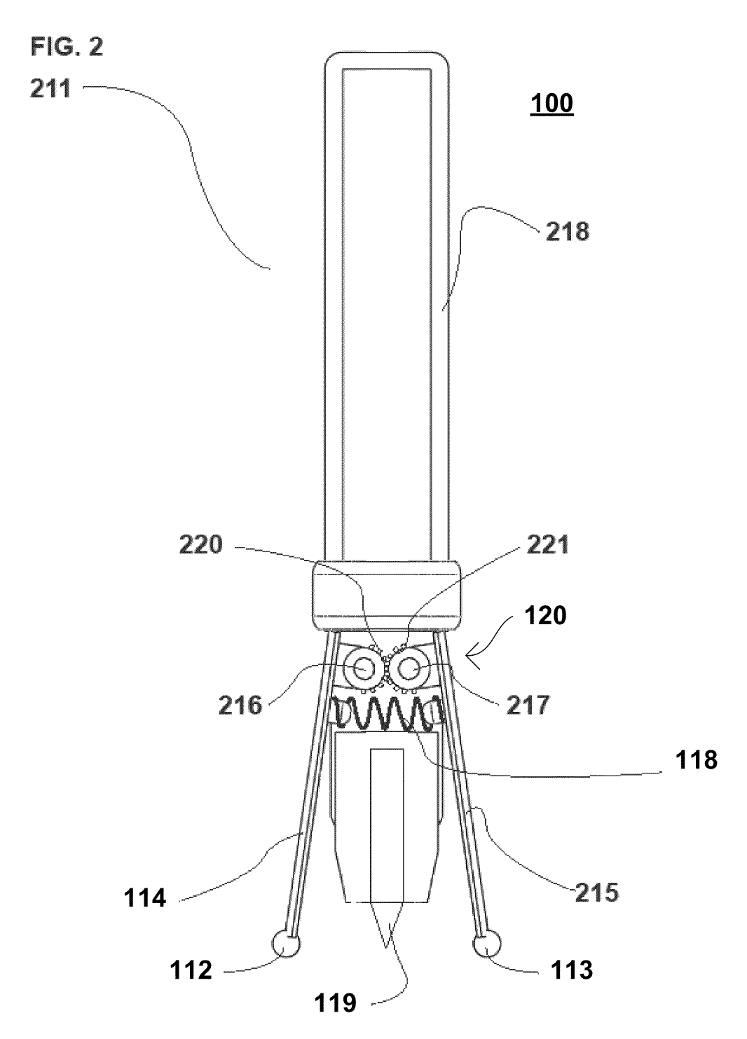

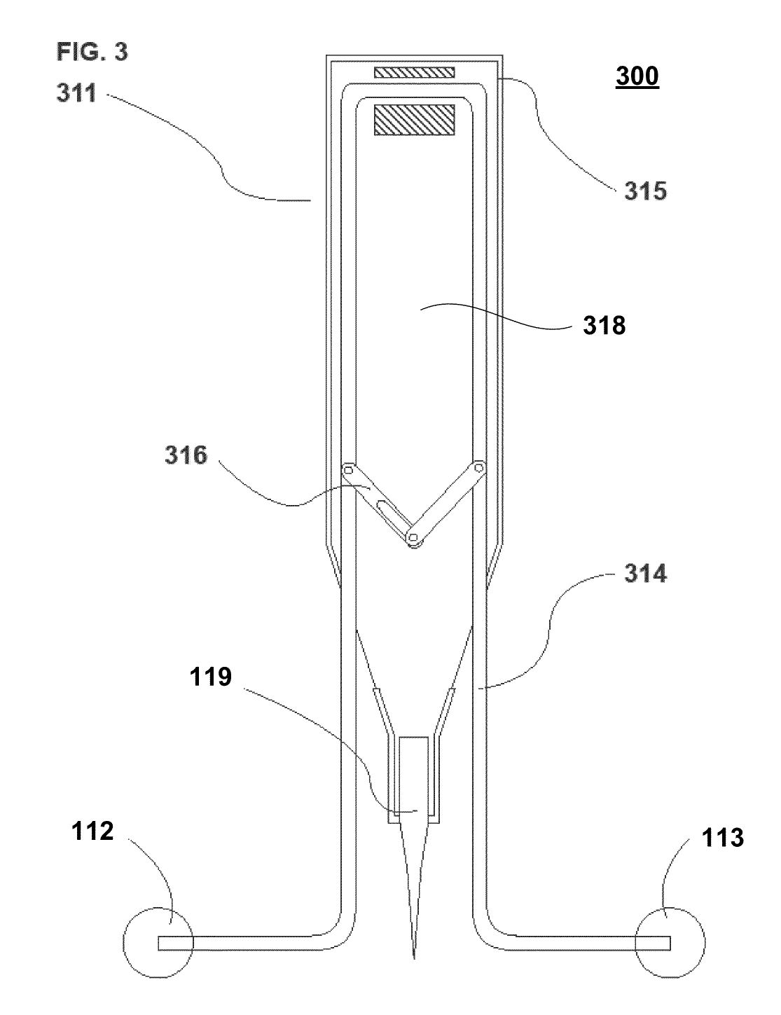

As shown in FIGS. 1A-1B, the plurality of arms 114 115 can extend from the stylus body 111. In some embodiments of the present invention, each of the plurality of arms 114 115 extend from the stylus body 111 via a coupling 120. The coupling 120 can allow the plurality of arms 114 115 to move relative to one another and/or the stylus body 111 when a pressure is applied to the arms 114 115 by a user. The coupling 120 can be many couplings known in the art for attaching or coupling two or more mechanical devices. In some embodiments, the coupling 120 is chosen such that the tips 112 113 on the arms 114 115 move a substantially equal distance when a pressure is applied by a user to at least one of the arms 114 115. For example, the coupling 120 may be chosen such that when pressure is applied to one or more of the plurality of arms 114 115, a first tip 112 on a first arm 114 moves a first distance and a second tip 113 on a second arm 115 moves a second distance substantially equal to the first distance. As shown in FIG. 1B, the coupling 120 can comprise a pin-in-slot joint. As shown in FIG. 2, the coupling can comprise one or more gears 220 221. As shown in FIG. 3, the coupling 120 can comprise a hinge 316.

As discussed above, the stylus can comprise an indicator 119. The indicator 119 can provide a visual indication of a center point among the plurality of tips 112 113. The indicator 119 can be comprised of many conductive and/or non-conductive materials known in the art, including, but not limited to, metals, plastics, alloys, and the like. In an exemplary embodiment of the present invention, the indicator 119 comprises plastic. In another exemplary embodiment, at least a portion of the indicator 119 comprises non-conductive, flexible foam, thus preventing the touchscreen device from interpreting the point where the indicator 119 contacts the touchscreen as the input; instead, the touchscreen device would interpret the points where tips 112 113 contact the touchscreen as the inputs. The indicator 119 can be many indicators known in the art to provide a visual reference. In some embodiments of the present invention, the indicator 119 can be positioned substantially between the plurality of tips 112 113 and provide a visual indication of a center point among the plurality of the tips 112 113. When a user is using the stylus 100 to provide an input to the touchscreen device, the location of the indicator 119 can mark the location of the user's desired input. For example, if a user is using the stylus 100 to draw a line on the touchscreen device, the location of the indicator 119 may indicate where the line is desired—a location substantially in the center of the two tips 112 113.

In some embodiments of the present invention, the stylus 100 further comprises one or more springs 118 coupled to one or more of the plurality of arms 114 115, the one or more springs 118 applying a force to the one or more plurality of arms 114 115. For example, as shown in FIGS. 1B and 2, the spring 118 can apply an outward force to the arms 114 115, pushing the arms 114 115, and thus the tips 112 113, away from the indicator 119. In such an embodiment, a user can apply a substantially opposite force by applying pressure to the exterior of the arms 114 115, pushing the arms 114 115 inward towards the indicator 119. Alternatively, although not shown in the figures, the spring 118 can apply an inward force to the arms 114 115, pulling the arms 114 115, and thus the tips 112 113, towards the indicator 119. In such an embodiment, a user can apply a substantially opposite force by applying a pressure to the arms 114 115, which pushes the arms 114 115 outward away from the indicator 119.

As those skilled in the art understand, capacitive touchscreens operate in part based on the conductivity of a user's body being placed in electrical communication with the touchscreen. Thus, in some embodiments of the present invention, at least a portion of one or more of the plurality of arms 114 115 comprises a conductive material providing electrical communication with the conductive tip 112 113 of the one or more arms 114 115. The conductive material may be many conductive materials known in the art, including, but not limited to, metals, metallic alloys, conductive plastics, and the like. In some embodiments of the present invention, one or more arms 114 115 comprise a strips or bands of conductive material placed on the outside of the arms, such that a user's fingers come into contact with the conductive material during use of the stylus 100. The conductive material can extend along the arms 114 115 making contact with conductive tips 112 113. Therefore, when a user grips the stylus 100 about the arms 114 115, the user is placed in electrical communication with the touchscreen device via the conductive material of the arm 114 115 and the conductive tips 112 113, thus allowing the touchscreen device to recognize an input.

In some embodiments of the present invention, the plurality of arms 114 115 have an open position and a closed position. The open position can result in a maximum distance between the plurality of tips 112 113. The closed position can result in a minimum distance between the plurality of tips 112 113. The arms 114 115 can move to various positions between the open and closed position when varying amounts of pressure are applied to one or more of the plurality of arms 114 115 by a user of the stylus 100. In some embodiments of the present invention, when no pressure is applied by a user, the arms 114 115 are in the open position, and when maximum pressure is applied by the user, the arms 114 115 are in the closed position, i.e., the distance between the tips 112 113 decreases as the pressure applied by the user increases. In some embodiments of the present invention, when no pressure is applied by a user, the arms 114 115 are in the closed position, and when maximum pressure is applied by a user, the arms 114 115 are in the open position, i.e., the distance between the tips 112 113 increases as the pressure applied by the user increases.

In some embodiments of the present invention, the stylus 100 further comprises a locking mechanism 116 for holding the plurality of arms 114 115 in the closed position. The locking mechanism 116 can be many locking mechanisms known in the art for holding the arms 114 115 in the closed position. In an exemplary embodiment, as shown in FIG. 1A, the locking mechanism 116 can be a slide fitting around at least a portion of the perimeter of the stylus body 111 and slideable over one or more of the arms 114 115, thereby securing the arms 114 115 in the closed position.

FIG. 3 provides a stylus 300 in accordance with another exemplary embodiment of the present invention. In its simplest form, the stylus 300 comprises a plurality of tips 112 113 and an elastic rail 314. The plurality of tips 112 113 can be for interfacing with the touchscreen device. The elastic rail 314 can be attached to at least one of the tips 112 113, such that pressure applied to the elastic rail 314 actuates the tips 112 113 closer together or farther apart in relation to one another. In some embodiments, the tips 112 113 are integral with the elastic rail, such that ends of the elastic rail 314 define the tips 112 113.

In some embodiments, the stylus 300 can further comprise a housing 315 enclosing the elastic rail 314. The elastic rail 314 can be attached to the housing 315 by pressure from snap-fit upper housing (not shown). In some embodiments of the present invention, the stylus 300 can further comprise a central shaft body 318 enclosed by the elastic rail 314.

In some embodiments of the present invention, the stylus 300 can further comprise an indicator 119 visualizing to a user a center point among the plurality of the tips 112 113. As discussed above, the indicator 119 can be many indicators known in the art. In some embodiments, the indicator 119 can be attached to the housing 315 by snap-fit upper housing (not shown). The indicator 119 can be positioned substantially between the tips 112 113.

In some embodiments of the present invention, at least one tip 112 113 and the elastic rail 314 comprise a conductive material, providing electrical communication between the user of the stylus 300 and the touchscreen device.

The stylus of the present invention has many uses with touchscreen devices. For example, during operation, one can use the stylus in a normal manner by placing a thumb on arm 114 and a finger on arm 115 and placing tip 112 and tip 113 onto the touchscreen. As the user moves stylus across the screen the device responds to the change in position of tip 112 and tip 113. One potential application is to draw a line at the midpoint between tip 112 and tip 113, e.g., directly below indicator 119. As the user applies pressure to arm 114 and arm 115 the arms rotate or flex and tip 112 and tip 113 move closer together. The change in distance between tip 112 and tip 113 is interpreted by the device and the input changes accordingly. In the previous example application the line drawn under indicator 119 can get wider or narrower as the distance between tip 112 and tip 113 decreases.

Accordingly, in addition to styli for interfacing with a touchscreen device, the present invention provides methods of using a stylus to interface with a touchscreen device. An exemplary embodiment of the present invention provides a method of interfacing with a touchscreen device. The method comprises providing a stylus comprising a first arm and a second arm, positioning first ends of the first and second arms proximate the surface of the touchscreen device, and actuating the first and second arms to vary a distance between the first ends of the first and second arms. The distance between the first ends of the first and second arms can be indicative of an input to the touchscreen device.

In some embodiments of the present invention, actuating the first and second arms can comprise applying pressure to the arms by a user. The pressure can cause the first ends of the first and second arms to move closer to each other or further apart from each other, depending on the configuration of the stylus used.

In some embodiments of the present invention, positioning the first ends of the first and second arms proximate the surface of the touchscreen device can comprise placing a user in electrical communication with the touchscreen device via the first and second arms.

In some embodiments of the present invention, at least a portion of the first and second arms, including the first ends of the first and second arms, comprises a conductive material. Thus, in some embodiments of the present invention, positioning the first ends of the first and second arms proximate the surface of the touchscreen device can comprise placing a user in contact with the conductive material.

The touchscreen device can be programmed to recognize the position of the tips of the stylus. Based on the position of the stylus, the device can obtain multiple inputs. Consider the exemplary use of the stylus of the present invention to draw a line on the touchscreen device. The user can move the stylus about the touchscreen in the shape of the line to be drawn. While moving the stylus about the touchscreen, the user can apply various levels of pressure to the arms or elastic rail of the stylus, thus changing the distance between the tips of the stylus. Accordingly, the touchscreen device may be programmed to recognize a center point between the tips, e.g., the position of the stylus indicator, which represent a first input indicating the position where the user desires to draw the line. Additionally, the touchscreen device may be programmed to recognize/calculate the distance between the two tips, which may represent a second input indicating the desired thickness of the line.

Those skilled in the art would appreciate the stylus of the present invention is not limited to use in only drawing a line. Instead, there are numerous applications for the present invention that would be understood by those skilled in the art. For example, instead of or in addition to indicating line thickness, a distance between the tips, or relative position of the tips (especially in cases of more than two tips), can indicate many other inputs to the touchscreen device, including, but not limited to, a click, a double-click, a select command, highlight command, copy, paste, cut, zoom in, zoom out, volume level, pitch, bass, or treble level of musical sounds, and the like. Thus, the distance between, orientation, or relative position of the tips can indicate both discrete and analog inputs to the touchscreen device. In the case of a discrete input, e.g., highlight or click command, the touchscreen device may be programmed to look for certain threshold values to be satisfied, e.g., a threshold distance between two tips.

Additionally, for some applications on the touchscreen device, only one of the two tips can be used. Thus, the touchscreen device can also be programmed to disregard as an input the position of one or more of the tips, and instead, recognize the position of one tip as an input. For these applications, the touchscreen can also be programmed to recognize the position of the indicator as the point of desired input instead of the position of the tip.

In some embodiments of the present invention, the touchscreen device may also be programmed to disregard conductive contacts points on the touchscreen other than the tips of the stylus, e.g., fingers or portions of a users hand resting on the touchscreen during use. For example, the touchscreen may be programmed to only look for two or more inputs arranged within a predetermined range of distances from each other, such that the undesired inputs are not recognized, or ar disregarded.

The styli of the present invention may also be fitted with pressure transducers/sensors for sensing a pressure applied to the stylus by a user. The pressure transducers/sensors can be located at various locations on the stylus, including, but not limited to, the tips, the indicator, the arms, and/or the stylus body. For example, instead of, or in addition to, movable arms, the arms can comprise one or more pressure transducers measuring pressure applied by the use of the stylus. The pressure can indicate an input by the user, like the distance of the tips from each other described earlier. Similarly, the tips and/or the indicator can comprise one or more pressure transducers measuring the pressure applied to the touchscreen by the user of the stylus. Measurements from the pressure transducers can be wirelessly communicated the touchscreen device in accordance with various wired and wireless protocols known by those skilled in the art. In an exemplary embodiment of the present invention, the stylus and the touchscreen device communicate wirelessly via Bluetooth technology.

Various embodiments of the present invention may be implemented with processor and memory. For example, the memory may store logical instructions that can be executed by the processor to perform the various actions described herein. The processor and or memory can be located on the stylus and/or touchscreen device, in accordance with various embodiments of the present invention. The processor may include any number of processors, controllers, integrated circuits, programmable logic devices, or other computing devices and resident or external memory for storing data and other information accessed and/or generated by the system. The processor may implement a computer program and/or code segments stored on memory to perform some the functions described herein. The computer program may comprise an ordered listing of executable instructions for implementing logical functions in the stylus and/or touchscreen device. The computer program can be embodied in any computer-readable medium (e.g., memory) for use by or in connection with an instruction execution system, apparatus, or device, and execute the instructions. Memory may contain, store, communicate, propagate or transport the program for use by or in connection with the instruction execution system, apparatus, or device. Examples of memory may include an electrical connection having one or more wires, a random access memory (RAM), a read-only memory (ROM), an erasable, programmable, read-only memory (EPROM or Flash memory), a portable computer diskette, or a portable compact disk read-only memory (CDROM). Memory may be integral with the stylus and/or touchscreen device, stand-alone memory, or a combination of both. Memory may include, for example, removable and non-removable memory elements such as RAM, ROM, Flash, magnetic, optical, USB memory devices, and/or other conventional memory elements.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions. Further, other modifications or embodiments as may be suggested by the teachings herein are particularly reserved as they fall within the breadth and scope of the claims appended hereto.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

What is claimed is:

1. A stylus for a capacitive touchscreen comprising:
a stylus body;
a plurality of arms extending from the stylus body via a coupling, each of the plurality of arms coupled to a conductive tip at a first end of the arm for interfacing with the capacitive touchscreen, the coupling allowing the plurality of tips to move relative to one another when pressure is applied to one or more of the plurality of arms by a user of the stylus; and
an indicator positioned substantially between the plurality of tips, the indicator providing a visual indication of a center point among the plurality of the conductive tips.

2. The stylus of claim 1, wherein the coupling comprises a pin-in-slot joint such that when the pressure is applied to one or more of the plurality of arms, a first tip in the plurality of tips moves a first distance and a second tip in the plurality of tips moves a second distance substantially equal to the first distance.

3. The stylus of claim 1, wherein the coupling comprises one or more gears such that when the pressure is applied to one or more of the plurality of arms, a first tip in the plurality of tips moves a first distance and a second tip in the plurality of tips moves a second distance substantially equal to the first distance.

4. The stylus of claim 1, wherein at least a portion of the indicator comprises a non-conductive material.

5. The stylus of claim 1, further comprising one or more springs coupled to one or more of the plurality of arms, the one or more springs applying an outward force to the one or more plurality of arms.

6. The stylus of claim 1, wherein at least a portion of one or more of the plurality of arms comprises a conductive material providing electrical communication with the conductive tip of the one or more arms.

7. The stylus of claim 1, wherein the plurality of arms have an open position and a closed position, the open position representing a maximum distance between the plurality of tips, the closed position representing a minimum distance between the plurality of tips, such that the arms move to various positions between the open and closed position when varying amounts of pressure are applied to one or more of the plurality of arms by a user of the stylus.

8. The stylus of claim 7, further comprising a locking mechanism for holding the plurality of arms in the closed position.

9. A stylus for providing an input to a touchscreen device comprising:
a plurality of tips for interfacing with the touchscreen device; and
an elastic rail attached to at least one of the tips,
wherein pressure applied to the elastic rail actuates the drawing tips closer together or farther apart in relation to one another.

10. The stylus of claim 9, further comprising an indicator visualizing to a user a center point among the plurality of the tips.

11. The stylus of claim 9, further comprising a housing enclosing the elastic rail.

12. The stylus of claim 9, further comprising a central shaft body, the elastic rail enclosing the central shaft body.

13. The stylus of claim 9, further comprising a pin-in-slot joint attached to the elastic rail ensuring that movement of one end of the elastic rail results in a substantially equal movement of the opposite end of the elastic rail.

14. The stylus of claim 9, wherein at least one tip and the elastic rail are made of a conductive material.

15. A method of interfacing with a touchscreen device comprising:
providing a stylus comprising a first arm and a second arm;
positioning first ends of the first and second arms proximate a surface of the touchscreen device; and
actuating the first and second arms to vary a distance between the first ends of the first and second arms,
wherein the distance between the first ends of the first and second arms is indicative of an input to the touchscreen device.

16. The method of claim 15, wherein actuating the first and second arms comprises applying pressure to the arms by a user, the pressure causing the first ends of the first and second arms to move closer to each other.

17. The method of claim 15, wherein positioning the first ends of the first and second arms proximate the surface of the touchscreen device comprises placing a user in electrical communication with the touchscreen device via the first and second arms.

18. The method of claim 17, wherein at least a portion of the first and second arms, including the first ends of the first and second arms, comprises a conductive material, and wherein positioning the first ends of the first and second arms proximate the surface of the touchscreen device comprises placing a user in contact with the conductive material.

19. The method of claim 15, wherein the input is a discrete input.

20. The method of claim 15, wherein the input is an analog input.
